(19) United States
(12) Patent Application Publication
(10) Pub. No.: US 2024/0010047 A1
(43) Pub. Date: Jan. 11, 2024

(54) VENTURI VENTILATOR FOR AN ENCLOSURE

(71) Applicant: Rivian IP Holdings, LLC, Irvine, CA (US)

(72) Inventor: Graham Lloyd Feltham, Irvine, CA (US)

(21) Appl. No.: 17/811,809

(22) Filed: Jul. 11, 2022

(51) Int. Cl. B60H 1/24; B60H 1/30; B60H 1/26; B60H 1/00; B60H 1/34; B60H 3/06

(52) U.S. Cl. CPC B60H 1/248; B60H 1/30; B60H 1/262; B60H 1/00564; B60H 1/00778; B60H 1/34; B60H 3/0641

(57) ABSTRACT

Embodiments of the present invention provide techniques for ventilating an enclosure such as the cargo space of a vehicle. In an example implementation, a ventilator is affixed to an external wall (e.g., the roof) of the cargo space. The ventilator includes a ram inlet that flows into a venturi, along one or more openings in a boundary of the cargo space, and exits at an outlet. When the vehicle is in motion, external airflow enters the ram inlet, gets compressed in the venturi, and travels over the top of the boundary, generating a high shear that pulls airflow from the cargo space, into the diffuser, and out the outlet. The ventilator may include an electric fan that generates suction from the cargo space when the vehicle is stationary, and a moveable flap at the inlet that directs the suction towards the cargo space when the vehicle is stationary.

### INTRODUCTION

The present disclosure is directed to techniques for ventilation of an enclosure, such as the cargo space of a vehicle.

### SUMMARY

Embodiments of the present invention provide techniques for ventilating an enclosure such as the cargo space of a vehicle. In an example implementation, a ventilator is affixed to an external wall (e.g., the roof) of the cargo space. The ventilator includes a ram inlet that flows into a venturi, along one or more openings in a boundary of the cargo space, and exits at an outlet. When the vehicle is in motion, external airflow enters the ram inlet, gets compressed in the venturi, and travels over the top of the one or more openings in the boundary, generating a high shear that pulls airflow from the cargo space, into the diffuser, and out the outlet. The ventilator may include an electric fan that generates suction from the cargo space when the vehicle is stationary, and a moveable flap at the inlet that opens at a threshold vehicle speed and closes below a threshold vehicle speed, directing the suction of the electric fan towards the cargo space.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Illustrative embodiments are described in detail below with reference to the attached drawing figures, wherein:

FIG. 1 is a cross-section of an example enclosure with an example ventilator, in accordance with various embodiments;

FIG. 2 is a perspective view of an example ventilator, in accordance with various embodiments;

FIG. 3 is a cross-section of an example ventilator, in accordance with various embodiments;

FIG. 4 is a cross-section of an example ventilator with a moveable flap, in accordance with various embodiments;

FIG. 5A is a cross-section of an example ventilator with an open ram airflow path, in accordance with various embodiments;

FIG. 5B is a cross-section of an example ventilator with a moveable flap in a closed position and a closed ram airflow flow path, in accordance with various embodiments;

FIG. 5C is a cross-section of an example ventilator with a moveable flap in an open position and an open ram airflow flow path, in accordance with various embodiments; and

FIG. 6 is an example method of ventilating an enclosure, in accordance with various embodiments.

### DETAILED DESCRIPTION

### Overview

The cargo space of a commercial vehicle is not typically thermally conditioned (unless required for food or perishable storage). However, hot weather climates can create a high level of solar loading, which results in heat transfer through a metal roof and into the cargo space, potentially superheating the cargo space. For example, if a vehicle is parked in an Arizona parking lot where the ambient temperature is 43° C., after an hour or two, the temperature in the cargo space can increase by almost 30° C. above the ambient temperature to about 73° C. This elevated temperature is too hot for human survival and places an extreme strain on any drivers or operators that must enter the cargo space throughout the day.

To compensate for heat transfer into a cargo space, ventilation techniques seek to exchange hot air in the cargo space with relatively cooler ambient air. However, existing ventilation techniques have a variety of drawbacks. For example, passive ventilators that activate in response to air flow generated when driving (e.g., spinning roof mounted devices that act under wind) typically do not provide enough airflow to be effective against the highest levels of solar loading a vehicle may be exposed to. Active ventilators (e.g., electric fans mounted in a hole in the roof) are used in recreational vehicles (RVs), buses, and commercial vehicles, but typically do not work very well when a vehicle is driving, as driving can make the suction generated by active ventilation less effective. Furthermore, when active ventilators are mounted in a hole in the roof, rain can enter through the hole, which is undesirable. At the extreme end, fully integrated roof-mounted active coolers (e.g., heat-pumps) can be installed for up to >4 kW of cooling power. However, active coolers may not be suitable for various reasons, including the impact of their larger size on vehicle form factor, which can impact shipping or driving clearances, increase drag during operation, reduce energy efficiency, and/or reduce driving range.

Accordingly, embodiments of the present invention are directed to techniques for ventilating an enclosure, such as the cargo space of a vehicle. In an example implementation, a ventilator that is affixed to or otherwise positioned on an external surface of the cargo space generates suction flow out of the cargo space using ram air at higher vehicle speeds and/or using one or more electric fans at lower vehicle speeds. An example ventilator includes a ram inlet that flows into a venturi (or venturi tube), then along one or more openings in a boundary of the cargo space (e.g., a louvered or perforated grille, slats), and finally exits the ventilator at an outlet. When the vehicle is in motion, external airflow (ram air) may enter the ram inlet and get compressed in the venturi, substantially increasing the velocity and reducing the pressure of the airflow. This flow resulting from the Venturi effect travels over the top of the opening(s) in the boundary of the cargo space and generates a high shear, which acts to pull flow through the boundary (e.g., through louvers) from the cargo space and into the main jet, which expands in the diffuser and exits through the outlet. When the vehicle is stationary or at lower speeds, one or more electric fans may be activated or throttled up to provide suction through the boundary of the cargo space. At higher speeds and/or above a threshold speed, the electric fan(s) may be deactivated or throttled down as ram intake becomes more effective at generating the suction.

In some embodiments, the ram inlet includes a moveable flap that blocks the airflow based on vehicle speed, and may be operated passively (e.g., spring loaded shut and opened by ram air), using an electro-mechanical device (e.g., an electromechanical actuator, a stepper motor, active grill shutters) driven by a control signal that corresponds to vehicle speed, and/or otherwise. In some embodiments with a moveable flap, when the vehicle is in motion, the moveable flap may be opened (e.g., gradually as vehicle speed increases), thereby opening the ram airflow path of the ventilator, and the fan(s) of the ventilator may be turned off or throttled down (e.g., gradually as vehicle speed increases). By contrast, when the vehicle is below a threshold speed and/or stationary, the fan(s) of the ventilator may be turned on or throttled up (e.g., gradually as vehicle speed deceases) to compensate for the reduced ram airflow, and the moveable flap may be closed (e.g., gradually as vehicle speed deceases) in order to close the ram inlet and direct the suction of the fan(s) toward the cargo space.

In some embodiments, the boundary between the ventilator and the cargo space may be formed with one or more open areas that permit airflow from the cargo space and one or more solid areas that create a boundary that controls expansion in the diffuser and maintains the Venturi effect. For example, the interface between the ventilator and the cargo space may be formed with a louvered grill, a perforated grille, slats, and/or otherwise. In some embodiments, the interface includes a grille that encourages or guides airflow out of the cargo space (e.g., via perforations with bell mouthed inlets, tapered radii, and/or sharp-edged outlets). In some embodiments, the interface includes an inner grille that encourages airflow out of the cargo space paired with an outer grille (e.g., a louvered grille) such that the openings of the outer grill are aligned with a solid portion of the inner grille, and the inner grille acts as a drip tray that catches falling water that entered into the ventilator and transmits the water to a water drain out of the vehicle.

Various fan arrangements are possible, such as at the boundary of the cargo space or at the outlet of the ventilator. In some implementations with one or more fans at the outlet, the fan(s) are tilted to reduce the vertical height of the ventilator and/or positioned under a grille (e.g., a louvered grille) for water protection.

Generally, any number of ventilators may be placed at any suitable location or locations on an enclosure, such as the roof of a cargo or auxiliary space of a vehicle. For example, a cargo space may be subdivided (e.g., with bulkheads), and multiple ventilators may be used to ventilate multiple subdivisions of the cargo space. In some embodiments, the ram inlet of a ventilator is elevated off the roof or other surface of the enclosure by an amount that avoids the thermal boundary layer of heated air on the surface. Since the thermal boundary layer is typically larger towards the rear of a vehicle, the farther back the ventilator is located on a roof, the higher the ram inlet may be elevated, and vice versa. Although some embodiments described herein contemplate a roof-mounted ventilator, a ventilator may additionally or alternatively be located on any suitable surface or boundary of an enclosure, such as on one or both sides of a vehicle, multiple ventilators on a particular surface, and/or other configurations. Furthermore, although some embodiments described herein contemplate ventilating a cargo space, generally any enclosure may be ventilated using the present techniques, such as some other auxiliary or storage space, an electronics enclosure, or other spaces or volumes. Furthermore, a ventilator may be used to ventilate a space in any suitable vehicle, such as a car, truck, bus, train, boat, or drone, to name a few examples. Moreover, although some embodiments described herein contemplate ventilating a moveable enclosure such as a cargo space of a vehicle, some embodiments use a ventilator to ventilate a stationary enclosure, with wind used for ram air. As such, the structures described herein may be used to apply ventilation that compensates for even the high solar loading that can occur in various environments.

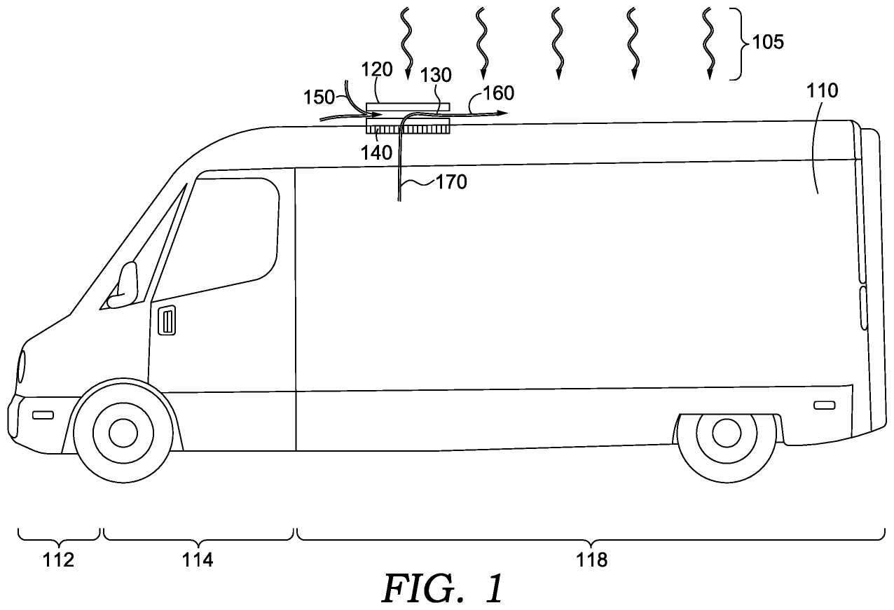

FIG. 1 is a cross-section of an example enclosure 110 with an example ventilator 120, in accordance with various embodiments. Depending on the implementation, the enclosure 110 may be inside a vehicle such as a car, truck, bus, train, boat, or drone; may be an electric vehicle such as an electric truck, electric sport utility vehicle (SUV), electric delivery van, electric automobile, electric car, electric motorcycle, electric scooter, electric passenger vehicle, electric passenger or commercial truck, or hybrid vehicle; or may be some other enclosure. In embodiments where the enclosure 110 is in a vehicle, the vehicle may include a chassis (e.g., a frame, internal frame, or support structure) that supports various components of the vehicle and that may span a front portion 112 (e.g., a hood or bonnet portion), a body portion 114, and a rear portion 118 (e.g., a cargo or auxiliary space, a payload, a trunk, or boot portion) of the vehicle. Note the enclosure 110 may include one or more features that can be opened or closed (e.g., doors, windows). When opened, the enclosure 110 may be considered at least partially enclosed.

In some embodiments where the enclosure 110 is in a vehicle, the vehicle includes one or more electrical power systems, whether alternating or direct current (AC or DC), at any suitable current and voltage, and one or more power sources such as a battery (e.g., a 12V battery), solar panel, or electric generator, to name a few examples. In an example implementation involving an electric vehicle, the electric vehicle may be fully electric or partially electric (e.g., plug-in hybrid), and may be fully autonomous, partially autonomous, unmanned, human-operated, non-autonomous, or otherwise. An electric vehicle such as an electric truck or automobile may include on-board battery packs, battery modules, or battery cells to power the electric vehicle. A battery, battery pack, battery module, and/or battery cell may be installed or placed within the vehicle (e.g., installed on the chassis of the vehicle within one or more of the front portion 112, the body portion 114, or the rear portion 118), and may include or connect with at least one busbar (e.g., a current collector element) comprising electrically conductive material connecting or otherwise electrically coupling the battery, battery pack, battery module, and/or battery cell with other electrical components of the vehicle to provide electrical power to various systems or components of the vehicle.

In the example illustrated in FIG. 1, the enclosure 110 is subject to solar loading 105, which heats the enclosure 110 and the air inside. To provide ventilation, the enclosure 110 includes a ventilator 120 mounted, affixed, attached to, incorporated into, or otherwise positioned on a surface of the enclosure 110. Any suitable attachment method and attachment structure may be used, such as welding, brazing, screws, bolts, nails, pins, snap fits, dowels, rods, staples, bonding, and/or magnetism, to name a few examples. FIG. 1 illustrates an example embodiment where the ventilator 120 is located on the top of the enclosure 110 (e.g., the roof of a vehicle), but additional and/or alternative locations are possible. In FIG. 1, the ventilator 120 includes a channel 130 (or ram airflow path) that takes in ram airflow 150 when the enclosure 110 moves forward (because the vehicle moves forward) or in a direction that includes a forward component. The ram airflow 150 travels through the channel 130 and exits the ventilator 120 as output airflow 160. The ventilator 120 further includes an interface 140 with the rear portion 118 of the enclosure 110 (e.g., a cargo space of a vehicle). The interface 140 forms a boundary between the channel 130 of the ventilator 120 and the rear portion 118, and may comprise one or more openings (e.g., a single opening; one or more grilles, perforated sheets, slats, or other structures with multiple openings). The ram airflow 150 through the channel 130 generates shear at the interface 140, the shear induces suction on the rear portion 118, and the suction generates ventilation airflow 170 from the rear portion 118 into the channel 130 and out of the ventilator 120 as output airflow 160.

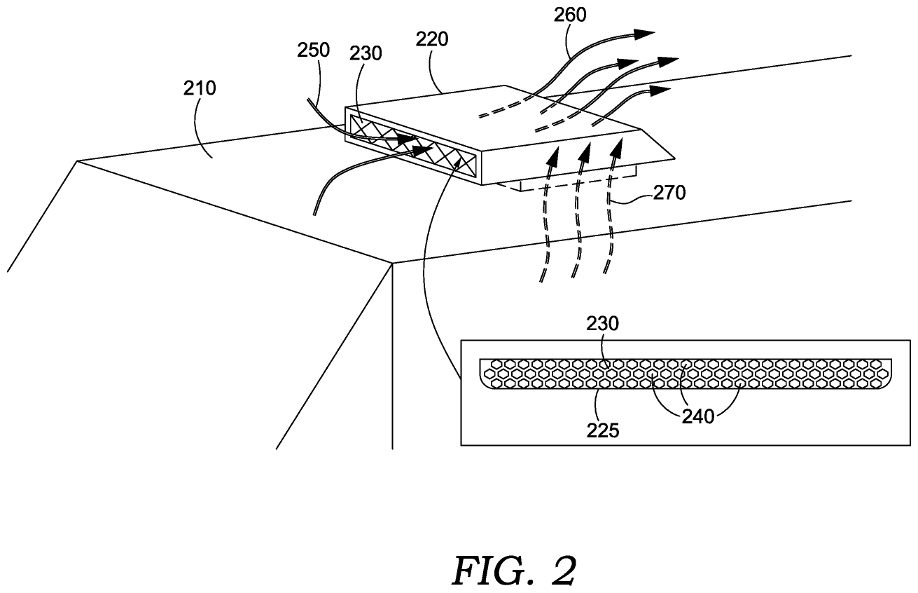

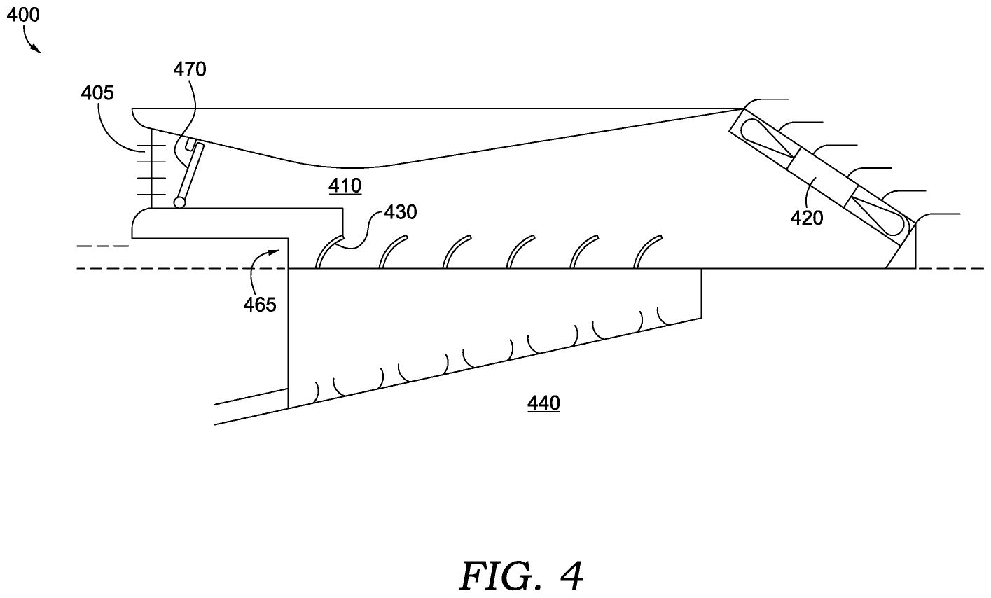

FIG. 2 is a perspective view of an example ventilator 220, in accordance with various embodiments. In this embodiment, the ventilator 220 is located on the roof 210 of an enclosure (e.g., the enclosure 110 of FIG. 1) and includes an aperture, opening, or other inlet that accepts ram airflow 250 (e.g., ram inlet 225). Generally, the perimeter of an aperture, the area inside the perimeter, and/or the total area of the aperture (e.g., an effective area that subtracts out the solid portion of a grille) can be characterized as an inlet (or an outlet, depending on the direction of airflow). In some embodiments, the ventilator 220 includes a grille 230 (or other partially open boundary) located at or inside the ram inlet 225 and that blocks debris from entering the ventilator 220. In the embodiment illustrated in FIG. 2, the grille 230 includes perforations 240 that allow ram airflow 250 to pass through into the ventilator 220 and induce ventilation airflow 260 from below the roof 210. In some embodiments, the ventilator 220 is composed of a white material such as white plastic, as white coloring can reduce the temperature of the ventilator 220 in the sun, can increase longevity of the ventilator 220, and/or control thermal expansion of the ventilator 220, or its components (e.g., a moveable flap, like the moveable flap 470 of ventilator 400 of FIG. 4).

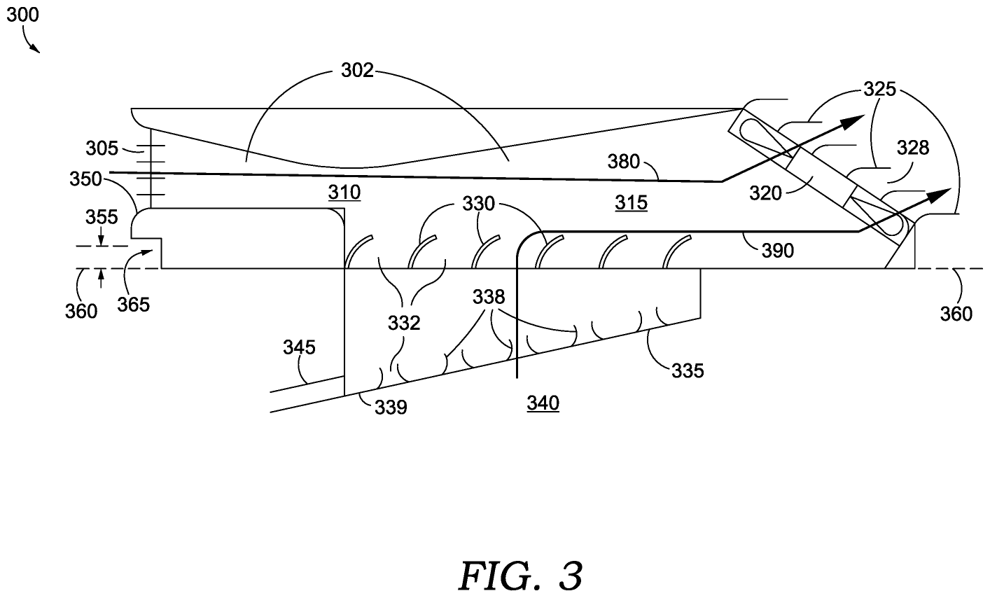

FIG. 3 is a cross-section of an example ventilator 300 located on a surface 360 of an enclosure (e.g., the roof of a vehicle), in accordance with various embodiments. In this embodiment, the ventilator 300 includes an inlet 305 (e.g., which may include a grille such as grille 230 of FIG. 2) that accepts ram airflow generated when the enclosure moves forward (or in a direction that includes a forward component), a channel or airflow path formed by a constricted portion (e.g., throat 310) and an expanding portion 315 (e.g., a diffuser), an interface (e.g., which may include one or more grilles, such as a louvered grille 330 and/or a perforated grille 335) between the expanding portion 315 of the ventilator 300 and an enclosed (or substantially enclosed) portion 340 of the enclosure to ventilate, and an outlet 328 (e.g., which may include a grille such as a louvered grille 325). In this embodiment, the ventilator 300 includes a venturi 302 (or venturi tube) formed by at least the inlet 305, the throat 310, and the expandable portion 315. When the enclosure moves forward (or if there is wind), external (ram) airflow enters the inlet 305, and is compressed in the throat 310, increasing the velocity and reducing the pressure of the airflow. As this airflow travels over the top of the louvered grille 330, the high shear acts to pull flow through the louvers (from the enclosed portion 340 of the enclosure) and into the main jet which is expanding in the expanding portion 315 (e.g., a diffuser). This airflow can also be thought of as higher pressure air within the enclosed portion 340 of the enclosure flowing into a venturi nozzle which is at a lowered pressure. As such, the ventilator 300 includes a ram airflow path 380 through the venturi 302, along one or more openings 332 in the interface or boundary with the enclosed portion 340, and out the outlet 328, as well as a suction flow path 390 from the enclosed portion 340 of the enclosure, through the one or more openings 332, and out the outlet 328.

In some embodiments, the interface between the expanding portion 315 of the ventilator 300 and the enclosed portion 340 of the enclosure includes one or more grilles, perforated sheets (e.g., with holes), slats, or other structures that form a partially open boundary. Generally, the opening(s) 332 provide ventilation for the enclosed portion 340 of the enclosure, while one or more solid portions (e.g., louvers of a louvered grille 330) create a boundary that controls expansion in the expanding portion 315 and maintains the Venturi effect. In some embodiments, one or more solid portions of the interface (e.g., louvers of a louvered grille 330 angled, for example, at 45°) form one or more turning veins that help direct ventilation airflow into the expanding portion 315 and turn the ventilation airflow towards the outlet 328 (e.g., towards the louvered grille 325), reducing resistance and turbulence. Generally, a variety of openings are possible. As a design principle, the percentage of the area of interface that is open may be selected to balance avoiding choking the ventilation airflow, blocking dirt or debris that may enter into the ventilator 300, and/or maintaining the Venturi effect. In a simple non-limiting example, the opening area may be approximately 50% of the area of the interface.

In some embodiments, the interface includes a grille (e.g., perforated grille 335) that encourages or guides airflow out of the cargo space (e.g., via perforations 338 with bell mouthed inlets, tapered radii, and/or sharp-edged outlets). Additionally or alternatively, the interface includes a slanted inner grille (e.g., perforated grille 335) paired with an outer grille (e.g., louvered grille 330) such that the openings of the outer grill are aligned with a solid portion 339 of the inner grille. As such, and using the embodiment illustrated in FIG. 3 as an example, if water enters into the ventilator 300 (e.g., through the inlet 305 or the louvered grille 325 at the outlet 328) and falls onto the louvered grille 330, the solid portion 339 of the perforated grille 335 below effectively acts as a drip tray that catches the falling water between the perforations 338 and, since it is slanted, transmits the water to one or more water drains (e.g., drain 345) routed out of the enclosure.

Various design principles may be considered when arranging, sizing, and/or locating various components of the ventilator 300. For example, the amount of compression in the venturi 302 depends on the ratio of the height of the inlet 305 to the height of the throat 310. An example compression ratio may be between 1:1 and 4:1 (e.g., 2:1). Although there would be no compression (and no venturi) with a ratio of 1:1, ram airflow through such a channel would still generate shear along the interface with the enclosed portion 340 of the enclosure. Compression ratios above 4:1 are possible, but may be less effective since less air may be captured.

In some embodiments, the enclosure includes a hole (e.g., in the roof) that accommodates the ventilator 300 (e.g., the louvered grille 330 and/or the perforated grille 335), and the size of the hole may be chosen to control how rapidly expansion occurs in the venuri, to make room for a fan (e.g., an interface-mounted fan), to provide separation between the inlet 305 and the outlet 328 (e.g., the louvered grille 325) to limit water ingestion, and/or other considerations. In a nonlimiting example technique, starting with the cross-section view as illustrated in FIG. 3 slicing from the front of the enclosure to the back (e.g., from the front portion 112 to the rear portion 118 of FIG. 1), the length of the hole (in which the louvered grille 330 and the perforated grille 335 sit) may be chosen to maximize the Venturi effect in the ventilator 300. Water management features may be considered (e.g., spacing out the inlet 305 and the outlet 328 or the louvered grille 325 to reduce water intake, spacing out the hole and the outlet 328 formed by the louvered grille 325 so water falling through the outlet 328 does not fall directly into the hole). Finally, the cross-width of the hole (e.g., from the left of the enclosure to the right) may be sized to scale the effectiveness of the Venturi effect.

In some embodiments, the inlet 305 is spaced away from the surface 360 of the enclosure to avoid taking in air from the thermal boundary layer 355 on or adjacent to the surface 360. For example and returning to FIG. 1, note that the solar loading 105 may effectively heat the surface of the enclosure 110, and the surface heats the adjacent air, creating a thermal boundary layer of heated air sitting on top of the surface. As the enclosure 110 travels forward, air flows over the enclosure 110 and picks up heat along the way. As a result, the thermal boundary layer often increases in height from the front portion 112 to the rear portion 118. Accordingly, and returning to FIG. 3, the standoff distance separating the inlet 305 from the surface 360 may be sized to avoid taking in air from the thermal boundary layer 355. Since the thermal boundary layer 355 is often smaller towards the front of an enclosure, the standoff distance may be lower when the ventilator 300 is placed towards the front of the enclosure, and higher when placed toward the back. In the example illustrated in FIG. 3, the inlet 305 is separated from the thermal boundary layer 355 by a protuberance 350, and the protuberance 350 is separated from the surface 360 by a cavity 365 that is larger than the thermal boundary layer 355. In this manner, when the enclosure is moving forward, air from the thermal boundary layer 355 enters the cavity and gets deflected around the ventilator 300, instead of entering the inlet 305. An example configuration might standoff the inlet 305 one inch off the surface 360 of the enclosure.

In FIG. 3, the ventilator 300 includes an electric fan 320 mounted, affixed, attached to, incorporated into, or otherwise positioned at the outlet 328 of the ventilator 300, and the electric fan 320 may be powered by a power source (e.g., a 12V system) available to the enclosure (e.g., vehicle). Any suitable attachment method and attachment structure may be used, such as welding, brazing, screws, bolts, nails, pins, snap fits, dowels, rods, staples, bonding, and/or magnetism, to name a few examples. In FIG. 3, the electric fan 320 is slanted or angled relative to the surface 360 to reduce the height of the ventilator 300. Furthermore, given a maximum or target ventilator height (or standoff distance), angling the electric fan 320 also enables the use of a larger fan diameter, which can provide more airflow than smaller diameter fans. In FIG. 3, the electric fan 320 is illustrated in a position underneath a solid portion of a grille (e.g., louvers of the louvered grille 325) to provide water protection for the electric fan 320. Note the choice of one electric fan and the location illustrated in FIG. 3 are meant as examples, and other embodiments use any number of fans (e.g., one 14″ fan, two 6″ fans side-by-side) and any suitable location (e.g., in the interface between the expanding portion 315 of the ventilator 300 and the enclosed portion 340 of the enclosure).

In some embodiments, the electric fan 320 may be controlled using a control signal that represents speed of the enclosure. For example, the electric fan 320 may be may be activated or throttled up at lower speeds (e.g., below 10 to 15 mph), and/or may be deactivated or throttled down at higher speeds (above 10 to 15 mph). Speed may be measured or otherwise determined using any suitable technique (e.g., using a vehicle or transmission speed sensor, using an airspeed indicator or gauge, determining changes in radiolocated position over time, etc.), and an electronic representation of the speed may be used to generate a control signal that drives the electric fan 320. For example, a vehicle speed sensor may output a speed signal, and the speed signal may be scaled, offset, gain controlled, regulated, and/or otherwise mapped on a desired voltage range, and the resulting control signal may be applied to the electric fan 320. In some embodiments, the electric fan 320 may be activated below a threshold speed (e.g., 10 mph), throttled gradually over a range of speeds (e.g., 10-15 mph), and/or deactivated above a threshold speed (e.g., 15 mph).

FIG. 4 is a cross-section of an example ventilator 400 with a moveable flap, in accordance with various embodiments. In this example, the components of ventilator 400 generally correspond with the components of the ventilator 300 of FIG. 3, with a few differences. For example, the ventilator 400 includes a moveable flap 470 inside the inlet 405 of the ventilator 400, the cavity 465 is elongated and extends farther into the ventilator 400 than the cavity 365 of the ventilator 300, and the left most louver 430 is nested underneath the throat 410.

The moveable flap 470 may comprise a hinged or otherwise actuated door that blocks the inlet 405 based on speed of the enclosure. In some embodiments, the moveable flap 470 is controlled passively. For example, the moveable flap 470 may be spring loaded shut with a spring selected to balance the force applied on the moveable flap 470 by ram airflow up to a desired threshold speed (e.g., 10 to 15 mph). As such, the moveable flap 470 may remain spring loaded shut when the enclosure is moving at lower speeds, and may gradually open and allow ram airflow to enter the ventilator 400 at higher speeds.

In some embodiments, the moveable flap 470 is controlled using some electro-mechanical device (e.g., an electromechanical actuator, a stepper motor, active grill shutters) driven by a control signal that corresponds to speed of the enclosure. For example, and as described in more detail above, speed may be measured or otherwise determined using any suitable technique and an electronic representation of the speed may be used to generate a control signal that drives the electro-mechanical device and actuates the moveable flap 470. For example, a vehicle speed sensor may output a speed signal, the speed signal may be scaled, offset, gain controlled, regulated, and/or otherwise mapped on a desired voltage range, and the resulting control signal may be applied to the electro-mechanical device to open and shut the door at a desired speed (or over a desired range of speeds). In some embodiments, the moveable flap 470 may be shut below a threshold speed (e.g., 10 mph), gradually opened over a range of speeds (e.g., 10-15 mph), and/or open above a threshold speed (e.g., 15 mph).

In some embodiments that include both an electric fan (e.g., the electric fan 420) and a moveable flap (e.g., the moveable flap 470), the electric fan and the moveable flap may both be controlled using vehicle speed. For example, when the enclosure is in motion, the moveable flap 470 may be opened (e.g., gradually as speed increases), thereby opening the ram airflow path of the ventilator 400, and the electric fan 420 may be turned off or throttled down (e.g., gradually as speed increases). By contrast, when the enclosure is below a threshold speed and/or stationary, the electric fan 420 may be turned on or throttled up (e.g., gradually as speed deceases) to compensate for the reduced ram airflow, and the moveable flap 470 may be closed (e.g., gradually as speed deceases) in order to block the inlet 405 and direct the suction of the electric fan 420 toward the enclosed portion 440 of the enclosure.

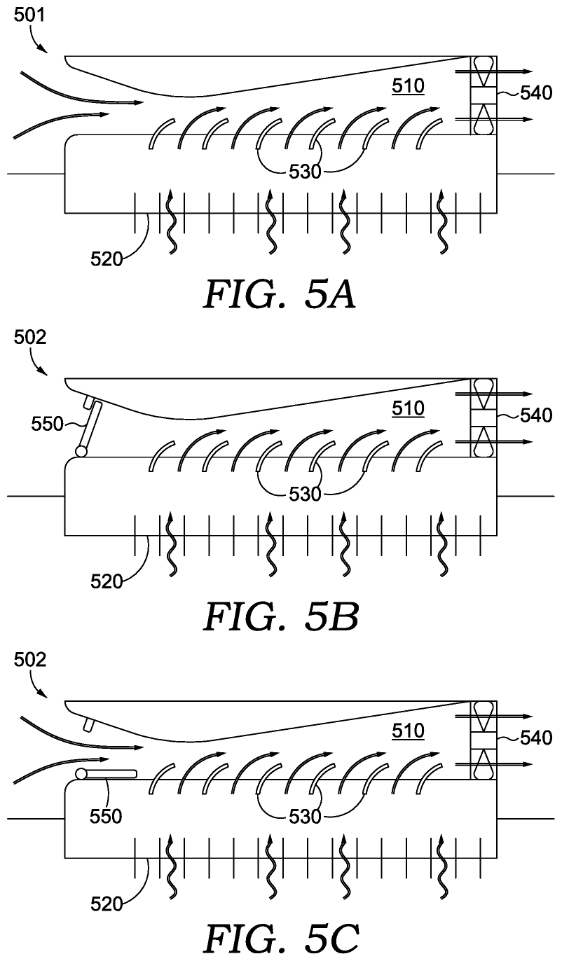

FIG. 5A is a cross-section of an example ventilator 501 with an open ram airflow path 510, in accordance with various embodiments. In this example, the ventilator 501 includes an electric fan 540 at the outlet, and a perforated grille 520 and a louvered grille 530 at the interface between the ventilator 501 and an enclosure on which it is located. When the enclosure is moving forward, ram airflow travels through the open ram airflow path 510, applying suction to the enclosure and generating ventilation airflow through the perforated grille 520 and the louvered grille 530. The electric fan 540 may be activated or throttled up below a threshold speed to apply suction to the enclosure and generate ventilation airflow through the perforated grille 520 and the louvered grille 530. The electric fan 540 may be deactivated or throttled down above a threshold speed since the ram airflow may be more effective at generating the suction than the electric fan 540 at those speeds.

FIG. 5B is a cross-section of an example ventilator 502 that corresponds to the ventilator 501 of FIG. 5A, but includes a moveable flap 550 in a closed position, so the ram airflow path 510 is closed. This state may occur when the enclosure is moving below a threshold speed. In this state, the electric fan 540 may apply suction to the enclosure and generate ventilation airflow through the perforated grille 520 and the louvered grille 530. With the moveable flap 550 in the closed position, the suction generated by the electric fan 420 is directed toward the enclosure below the perforated grille 520 and the louvered grille 530.

FIG. 5C is a cross-section of the ventilator 502 with the moveable flap 550 in an open position, so the ram airflow path 510 is open. This state may occur when the enclosure is moving above a threshold speed. In this state, the electric fan 540 may be off since ram airflow may be more effective at these speeds than the electric fan 540 at applying suction to the enclosure and generating ventilation airflow through the perforated grille 520 and the louvered grille 530.

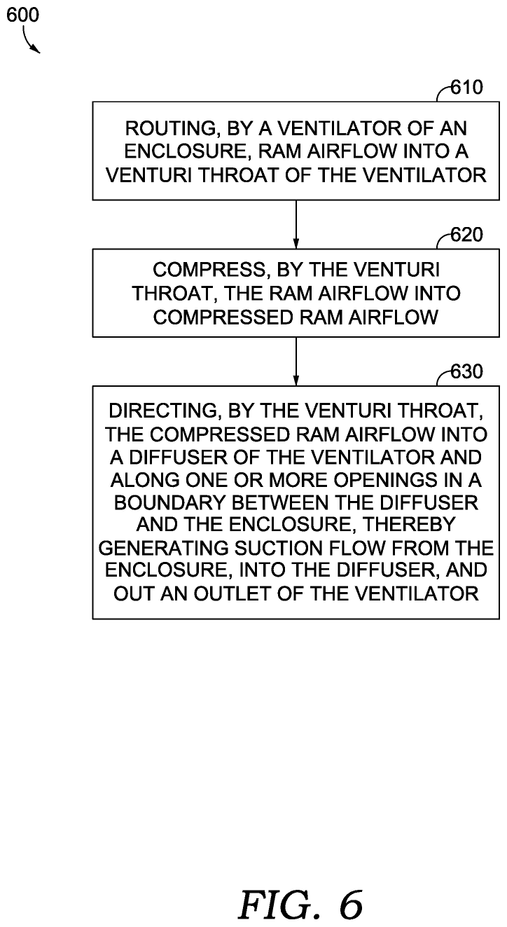

FIG. 6 illustrates an example method 600 of ventilating an enclosure (e.g., the enclosure 110 of FIG. 1, the enclosed portion 340 of an enclosure of FIG. 3). Initially at block 610, a ventilator (e.g., a ram inlet such as ram inlet 225 of FIG. 2, inlet 305 of FIG. 3, inlet 405 of FIG. 4) of an enclosure routes ram airflow (e.g., ram airflow 150 of FIG. 1) into a venturi throat (e.g., throat 310 of FIG. 3, throat 410 of FIG. 4) of the ventilator. At block 620, the venturi throat compresses the ram airflow into compressed ram airflow. At block 630, the venturi throat directs the compressed ram airflow into a diffuser (e.g., expanding portion 315) of the ventilator and along one or more openings in a boundary (e.g., the interface 140 of FIG. 1, the interface formed by the louvered grille 330 and the perforated grille 335 of FIG. 3) between the diffuser and the enclosure, thereby generating suction flow (e.g., the ventilation airflow 170 of FIG. 1) from the enclosure, into the diffuser, and out an outlet (e.g., the outlet formed by the louvered grille 325 of FIG. 3) of the ventilator.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure. For example, the fluid lines or fittings described can be configured for use in various other components including, but not limited to, plumbing systems or other piping systems. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A ventilator of an enclosure, the ventilator comprising:
a ram airflow path into a venturi, along one or more openings in a boundary of the enclosure, and out an outlet; and
a suction flow path from the enclosure, through the one or more openings of the boundary, and out the outlet,
wherein the ram airflow path is configured to ventilate the enclosure using shear along the one or more openings in the boundary to generate suction flow through the suction flow path.

2. The ventilator of claim 1, further comprising an electric fan positioned substantially at the outlet or the boundary, and configured to generate second suction flow through the suction flow path.

3. The ventilator of claim 1, further comprising: a moveable flap configured to close a ram inlet of the ventilator when the enclosure is stationary, and an electric fan in the suction path configured to generate second suction flow in the suction flow path when the enclosure is stationary.

4. The ventilator of claim 1, further comprising: a moveable flap configured to gradually open a ram inlet of the ventilator as speed of the enclosure increases, and an electric fan in the suction path configured to throttle down as the speed of the enclosure increases.

5. The ventilator of claim 1, wherein the boundary of the enclosure comprises a louvered or perforated grille.

6. The ventilator of claim 1, wherein the boundary of the enclosure comprises: a first grille with first openings, and a second grille that is positioned under the first grille and includes a solid portion configured to catch water falling through the first openings.

7. The ventilator of claim 1, wherein the boundary of the enclosure comprises a grille with perforations having tapered radii.

8. The ventilator of claim 1, wherein the enclosure is a cargo space of a vehicle, and the ventilator is positioned on a roof of the vehicle.

9. The ventilator of claim 1, wherein the enclosure is a portion of a cargo space subdivided using one or more bulkheads.

10. The ventilator of claim 1, wherein the shear is associated with a reduced pressure that induces the suction flow through the suction flow path.

11. A method comprising:
routing, by a ventilator of an enclosure, ram airflow into a venturi throat of the ventilator;
compressing, by the venturi throat, the ram airflow into compressed ram airflow; and
directing, by the venturi throat, the compressed ram airflow into a diffuser of the ventilator and along one or more openings in a boundary between the diffuser and the enclosure, thereby generating suction flow from the enclosure, into the diffuser, and out an outlet of the ventilator.

12. The method of claim 11, wherein the boundary of the enclosure comprises a louvered or perforated grille.

13. The method of claim 11, wherein the boundary of the enclosure comprises: a first grille with first openings, and a second grille that is positioned under the first grille and includes a solid portion configured to catch water falling through the first openings.

14. The method of claim 11, wherein the boundary of the enclosure comprises a grille with perforations having tapered radii.

15. The method of claim 11, wherein the enclosure is a cargo space of a vehicle, and the ventilator is positioned on a roof of the vehicle.

16. The method of claim 11, wherein the enclosure is a portion of a cargo space subdivided using one or more bulkheads.

17. A vehicle comprising:
a vehicle body defining a cargo space having one or more openings in a boundary;
a ventilator covering the one or more openings in the boundary and comprising:
a venturi throat configured to accept ram airflow from outside the vehicle;
a diffuser connected to the venturi throat and sharing the boundary with the cargo space; and
an outlet connected to the diffuser,
wherein the venturi throat is configured to direct compressed ram airflow along the one or more openings in the boundary, thereby generating suction flow from the cargo space, into the diffuser, and out the outlet.

18. The vehicle of claim 17, wherein the ventilator further comprises an electric fan positioned substantially at the outlet or the boundary, and configured to generate second suction flow from the cargo space.

19. The vehicle of claim 17, wherein the ventilator further comprises a moveable flap configured to close a ram inlet of the ventilator when the vehicle is stationary, and an electric fan configured to generate second suction flow from the cargo space when the vehicle is stationary.

20. The vehicle of claim 17, wherein the ventilator further comprises a moveable flap configured to gradually open a ram inlet of the ventilator as speed of the vehicle increases, and an electric fan configured to throttle down as the speed of the vehicle increases.
